(19) United States
(12) Patent Application Publication
(10) Pub. No.: US 2010/0141145 A1
(43) Pub. Date: Jun. 10, 2010

(54) BASE FOR A HIGH-PRESSURE DISCHARGE LAMP, AND HIGH-PRESSURE DISCHARGE LAMP.

(76) Inventors: Walter Bätz, Sindelsdorf (DE); Manfred Rôhi, Bruckmuhl (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/989,359

(22) PCT Filed: Aug. 4, 2006
(86) PCT No.: PCT/EP2006/007753

§ 371 Date: Jan. 24, 2008

(30) Foreign Application Priority Data
Aug. 9, 2005 (DE) 10 2005 038 043.3

(51) Int. Cl. H01J 7/44

(52) U.S. Cl. 315/57

(57) ABSTRACT

The invention relates to a base for a high-pressure discharge lamp comprising a transformer (300) that is disposed in a chamber (214) of the base (2). Sealing compound (6) is arranged in the interstice between the transformer (300) and the walls of said chamber (214). The terminal (301) of the secondary winding of the transformer (300), which is designed for high voltages, is embedded in the sealing compound (6). According to the invention, only some of the interstice is filled with the sealing compound (6).

The invention relates to a lamp base for a high-pressure discharge lamp in accordance with the preamble of patent claim 1 and to a high-pressure discharge lamp with such a lamp base.

I. Prior art

Such a lamp base is disclosed, for example, in EP 1 511 130 A1. This document describes a high-pressure discharge lamp for a motor vehicle headlamp with a lamp base, in which a transformer is arranged which is formed as part of a starting apparatus for the high-pressure discharge lamp. The transformer is located in a chamber of the lamp base, the interspace between the transformer and the walls of the chamber being completely filled with a casting compound, and the high-voltage connection of the secondary winding being embedded in the casting compound.

It has been shown that, with this lamp base, considerable forces act on the wall region of the chamber as a result of material shrinkage during curing of the casting compound and as a result of temperature fluctuations, which forces result in a visible deformation of the wall region and therefore the dimensional stability of the plastic base part is no longer ensured.

II. Description of the invention

The object of the invention is to provide a generic lamp base in which the abovementioned disadvantage is eliminated.

This object is achieved according to the invention by the features of patent claim 1. Particularly advantageous embodiments of the invention are described in the dependent patent claims.

The lamp base according to the invention for a high-pressure discharge lamp has a transformer, which is arranged in a chamber of the lamp base, casting compound being arranged in the interspace between the transformer and the walls of the chamber, and the connection, which is designed for high voltages, of the secondary winding of the transformer being embedded in the casting compound, which according to the invention only fills part of the interspace.

It has been shown that, in order to electrically insulate the transformer, the interspace between the transformer and the chamber walls does not need to be filled completely with casting compound. It is sufficient for the connection, which is designed for high voltages, of the secondary winding of the transformer to be embedded in the casting compound. As a result of the only partial casting of the transformer in the chamber of the lamp base, correspondingly lower forces are exerted by the casting compound on the chamber walls, and these forces do not result in any visible deformation of the chamber or base walls. In addition, less casting compound is therefore used.

In accordance with the preferred exemplary embodiment of the invention, the filling height of the casting compound above the bottom of the chamber is less than 50 percent of the height of the chamber, in order to keep the abovementioned forces as low as possible. In addition, the connection, which is designed for high voltages, of the secondary winding of the transformer is preferably arranged a small distance from the bottom of the chamber in order to ensure that the abovementioned connection of the secondary winding is embedded in the casting compound even in the case of a low filling height of the casting compound.

Preferably, the transformer has a housing, in which a magnetic core of the transformer, for example a ferrite core, and the secondary winding of the transformer are arranged, the remaining cavity in the housing being filled with the casting compound in order to allow for improved electrical insulation of the secondary winding of the transformer. The housing of the transformer preferably has at least one opening in order to make it possible for the casting compound to enter the cavity during the casting process. The housing of the transformer is advantageously designed to be closed above the fill level of the casting compound, and the at least one opening in the housing of the transformer is arranged completely within the casting compound. As a result, so-called vacuum casting of the housing of the transformer is made possible, the casting compound entering through the at least one opening in the housing and being sucked into the evacuated cavity of the transformer housing, so that the cavity between the housing and the magnetic core with the secondary winding is filled completely with the casting compound although the casting level is markedly lower in the vicinity outside the transformer.

Alternatively, the capillary effect can also be used for filling the cavity within the transformer housing.

### DESCRIPTION OF THE PREFERRED EXEMPLARY EMBODIMENT

The invention will be explained in more detail below with reference to a preferred exemplary embodiment. In the drawing:

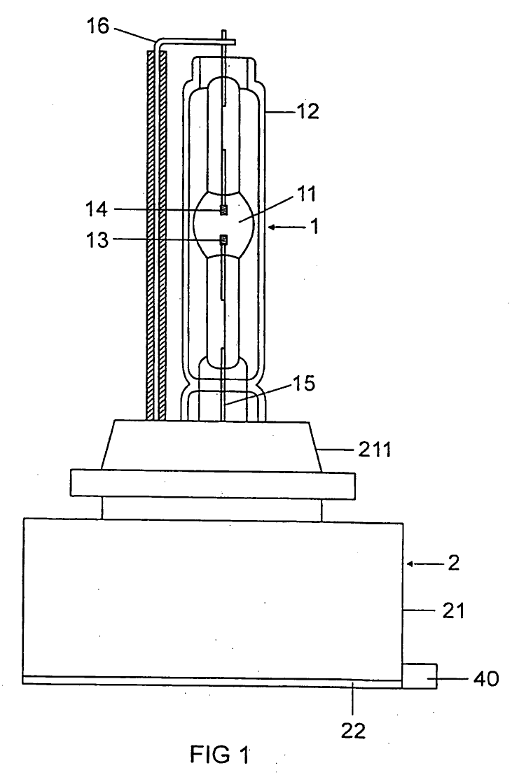

FIG. 1 shows a side view of a high-pressure discharge lamp according to the invention in a schematic illustration,

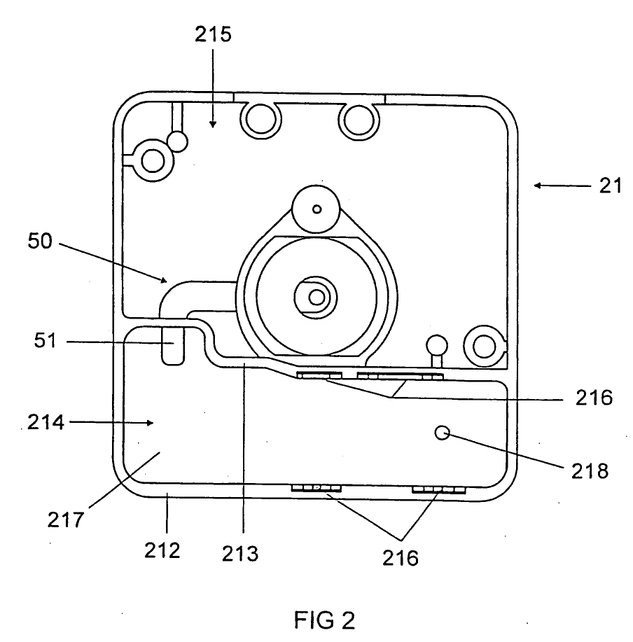

FIG. 2 shows a plan view of the interior of the lamp base of the high-pressure discharge lamp illustrated in FIG. 1,

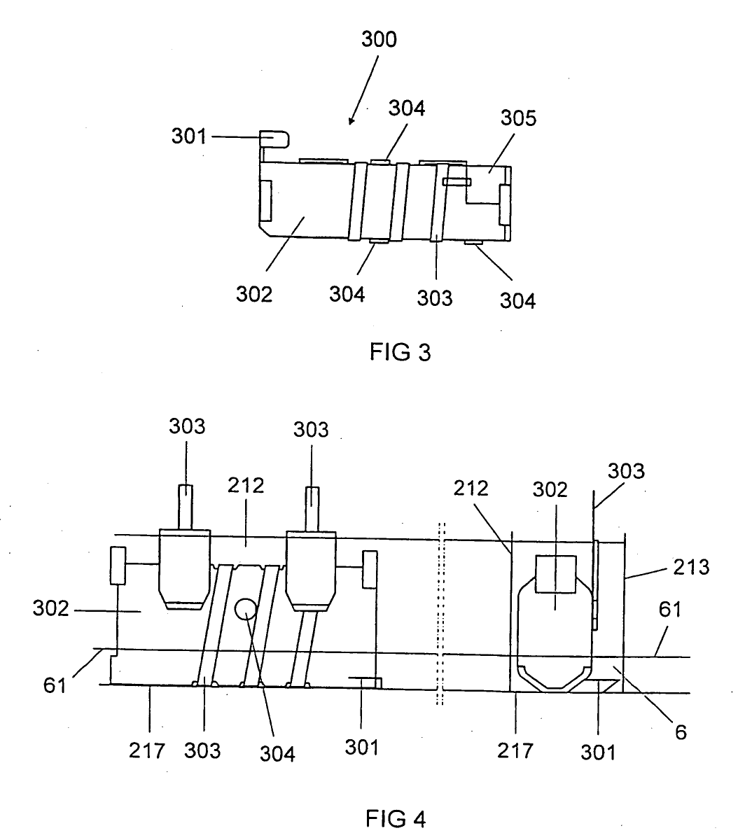

FIG. 3 shows a plan view of the transformer to be installed in the lamp base illustrated in FIG. 2, and

FIG. 4 shows a schematic illustration of two views of the chamber of the lamp base depicted in FIG. 2 with the transformer depicted in FIG. 3 being arranged therein.

The preferred exemplary embodiment of the invention depicted in FIG. 1 is a high-pressure discharge lamp with a base at one end for a motor vehicle headlamp. This high-pressure discharge lamp has a discharge vessel 11 made from quartz glass which is surrounded by a vitreous outer bulb 12 and with electrodes 13, 14 arranged therein for producing a gas discharge. The electrodes 13, 14 are each connected to a power supply line 15 and 16, respectively, which is passed out of the discharge vessel 11 and via which they are supplied with electrical energy. The structural unit 1 comprising the discharge vessel 11 and the outer bulb 12 is fixed in a receptacle 211 of the lamp base 2. The lamp base 2 has a substantially right-parallelepipedal lower part 21, in which the electrical component parts of a starting apparatus for the high-pressure discharge lamp are accommodated and which is equipped with the electrical connection 40 of the high-pressure discharge lamp.

FIG. 2 shows a plan view of that side of the lower part 21 which is remote from the lamp vessels 11, 12, before the cover is fitted. The lower part 21 has a substantially square cross section. The interior of the lower part 21 is split into two differently sized chambers 214, 215 by a partition wall 213. A rod-core transformer 300, which acts as the starting transformer for the pulse starting apparatus of the high-pressure discharge lamp accommodated in the lamp base 2, is arranged in the smaller, first chamber 214. The rod-core transformer 300 depicted in FIG. 3 has a secondary winding, which is arranged on a ferrite core, with a connection 301, which is designed for high voltages, the so-called starting voltage connection 301, a transformer housing 302, which surrounds the ferrite core and the secondary winding, and a primary winding 303, which is arranged on the housing 301 on its outside and is in the form of a metal strip 303.

A plurality of guide rails 216 for the rod-core transformer 300 depicted in FIG. 3 are arranged in the walls 212, 213 of the first chamber 214. The guide rails 216 are adjusted so as to fit on corresponding webs 304 on the housing 302 of the rod-core transformer 300, so that the position of the rod-core transformer 300 in the first chamber 214 is fixed thereby. In addition, a knob 218, which, together with that end 51 of a contact element 50 which protrudes into the chamber 214, determines the installation depth of the rod-core transformer 300, is located in the bottom 217 of the chamber 214. The starting voltage output 301 of the rod-core transformer 300 rests on that end 51 of the contact element 50 which protrudes into the chamber 214, which contact element 50 for its part is connected to the power supply line 15 which is close to the base and welded to it, while the housing 302 of the rod-core transformer 300 rests on the knob 218. The interspace between the rod-core transformer 300 and the walls of the first chamber 214 is filled with an electrically insulating casting compound 6 up to a filling height 61 of 5 millimeters above the bottom 217 of the chamber 214. That end 51 of the contact element 50 which protrudes into the chamber 214 and the starting voltage connection 301 connected thereto are embedded completely in the casting compound 6, as is illustrated schematically in the two views shown in FIG. 4. The total height of the chamber 214 above its bottom 217 is 21 millimeters. The filling height of the casting compound in the chamber 214 is therefore only approximately 24 percent of the height of the chamber.

The casting compound also enters the interior of the transformer housing 302 through two openings 305 in the transformer housing 302 which are arranged close to the bottom 217 of the chamber 214 and fills the previously evacuated cavity between the ferrite core with the secondary winding arranged thereon and the transformer housing 302 completely. A suitable casting compound 6 is, for example, silicone, which is cured after the casting process.

The remaining components of the pulse starting apparatus, in particular the starting capacitor and the spark gap, are arranged in the larger, second chamber 215. The cover 22 closes both chambers 214, 215 of the lower part 21.

1. A lamp base for a high-pressure discharge lamp with a transformer (300), which is arranged in a chamber (214) of the lamp base (2), casting compound (6) being arranged in the interspace between the transformer (300) and the walls of the chamber (214), and the connection (301), which is designed for high voltages, of the secondary winding of the transformer (300) being embedded in the casting compound (6), characterized in that only part of the interspace is filled with the casting compound (6).

2. The lamp base as claimed in claim 1, characterized in that the casting height of the casting compound (6) above the bottom (217) of the chamber (214) is less than 50 percent of the height of the chamber (214).

3. The lamp base as claimed in claim 2, characterized in that the distance between the connection (301), which is designed for high voltages, of the secondary winding of the transformer (300) and the bottom (217) of the chamber (214) is less than the casting height (61) of the casting compound (6) above the bottom (217) of the chamber (214).

4. The lamp base as claimed in claim 1, characterized in that the transformer (300) has a housing (302), in which a magnetic core of the transformer (300) and the secondary winding are arranged, the remaining cavity in the housing (302) being filled with the casting compound (6).

5. The lamp base as claimed in claim 4, characterized in that the housing (302) of the transformer (300) has at least one opening (305) for introducing the casting compound (6).

6. The lamp base as claimed in claim 5, characterized in that the at least one opening (305) for introducing the casting compound (6) into the housing (302) is arranged in the casting compound (6), and the housing (302) of the transformer (300) is designed to be closed above the fill level (61) of the casting compound (6) in the chamber (214).

7. A high-pressure discharge lamp with a lamp base as claimed in one or more of claims 1 to 6.
